(19) United States
(12) Patent Application Publication
(10) Pub. No.: US 2007/0260777 A1
(43) Pub. Date: Nov. 8, 2007

(54) Queues for information processing and methods thereof

(76) Inventors: Barrie Richard Timpe, Miamisburg, OH (US); Leszek Dariusz Wronski, Dayton, OH (US)

Correspondence Address: STEVENS & SHOWALTER LLP, 7019 CORPORATE WAY, DAYTON, OH, 45459-4238, US

(21) Appl. No.: 10/722,294

(22) Filed: Nov. 25, 2003

(51) Int. Cl. G06F 5/00

(52) U.S. Cl. 710/52

(57) ABSTRACT

Systems and methods implement queues that perform write operations in a re-circulating sequential manner. The nature of the queue systems of the present invention allow writes to the queue to occur independently of read operations therefrom. A current event counter is updated by the queue logic to keep track of a count value that corresponds to the total number of data events written to the queue. Preferably, the current event counter is capable of counting an amount greater than the total number of addressable storage locations of the queue. A write pointer may be derived from the count value stored in the event counter from which a select addressable storage location of the queue can be determined for queuing each new data event. Read operations from the queue may be performed according to any prescribed manner, including random access thereto. Moreover, read operations can be performed in a first manner when no overflow is detected, and in a second manner in response to overflow.

### BACKGROUND OF THE INVENTION

The present invention relates in general to queues for buffering information and in particular to systems and methods for writing to and reading from a queue such that writes to the queue operate independent of read operations from the queue, and read operations can be performed in any prescribed manner desired by the reading process.

There are numerous applications where it is necessary to buffer information that is passed from a first process to a second process for subsequent action thereon. For example, a receiving process may be too busy performing other operations to stop and service the new information. Alternatively, the receiving process may be too slow to service the incoming information in real time. To resolve this problem, a buffer is typically employed to temporarily store the incoming data until the receiving process can reserve sufficient resources to service the buffered information in an appropriate manner. One common buffering technique is to queue information in a stack and process the information from the stack in a predefined chronological sequence. For example, one common technique for writing to and reading from a queue is referred to as first in first out (FIFO). A FIFO is essentially a fixed size or block of memory that is written to, and read from, in a temporally ordered, sequential manner, i.e. data must be read out from the FIFO in the order in which it is written into the FIFO.

The FIFO may provide an adequate queuing system for some applications, however the FIFO is not without significant limitations in certain circumstances. For example, if write operations to the FIFO outpace read operations from the FIFO, it is possible that the FIFO can overflow. When overflow occurs, the FIFO essentially refuses new entries thereto until the FIFO can recover from the overflow, resulting in lost data. Because the FIFO preserves the data on a temporal basis, the oldest data is preserved, and the most recent data is thrown away. This chronological prioritizing scheme may not always provide an ideal solution, such as when the data in the FIFO has become stale relative to more valuable, recent data that is lost due to overflow.

Another technique for writing to and reading from a queue is commonly referred to as last in first out (LIFO). The LIFO is similar to the FIFO except that in a LIFO, the last data entered into the queue is the first data read out. However, the LIFO suffers from many of the same traditional shortcomings as the FIFO in that, when overflow occurs, the LIFO refuses new entries thereto until data has been successfully read out. Accordingly, it is possible, that the most recent information is lost because of LIFO overflow. Another disadvantage of both the LIFO and the FIFO in certain applications is that reading therefrom is destructive. That is, a read operation automatically updates a read pointer such that another process cannot directly access a previously read queue location. Still further, another disadvantage of both the LIFO and the FIFO in certain applications is that they are not randomly accessible. That is, read operations are carried out according to a rigid definition, chronologically for the FIFO, and reverse chronologically for the LIFO.

### SUMMARY OF THE INVENTION

The present invention overcomes the disadvantages of previously known queuing techniques by providing systems and methods that implement queues operatively configured to perform write operations in a re-circulating sequential manner. Read operations from the queue may be performed according to any prescribed manner, including random access thereto. The nature of the queue system allows writes to the queue to occur independently of read operations therefrom.

A queuing system according to an embodiment of the present invention comprises a queue having a plurality of addressable storage locations associated therewith and queue logic to control write operations to the queue. For example, the queue logic may be operatively configured to write data events to the queue in a re-circulating sequential manner irrespective of whether previously stored data has been read out. A current event counter is updated by the queue logic to keep track of a count value that corresponds to the total number of data events written to the queue. Preferably, the current event counter is capable of counting an amount greater than the total number of addressable storage locations of the queue. For example, by storing previous versions of the current event counter, it is possible to determine the number of times that the queue has overflowed, or to determine the number of writes that have occurred to the queue since the previously stored event counter was saved. Read logic is operatively configured to read event data from the queue according to a prescribed manner. The read logic utilizes a read pointer that relates to a position in the queue that data is to be read from. The read logic is operatively configured to read from the queue independently of write operations to the queue. The read logic is further communicably coupled to the current event counter for reading the count value stored therein. The read logic may use the count value for example, to affect how read operations are to be performed on the queue.

A queuing system according to another embodiment of the present invention comprises a queue having a plurality of addressable storage locations. An event counter is operatively configured to sequentially update a count value stored therein each time a new data event is written into the queue. The count value is preferably capable of storing a maximum count that exceeds the predetermined number of addresses of the queue. A write pointer is derived from the count value stored in the event counter from which a select addressable storage location of the queue can be determined for queuing each new data event. Queue logic is communicably coupled to the queue, the event counter, and the write pointer to control writing new data events to the queue. A read pointer is further provided from which a desired addressable storage location of the queue can be identified for a read operation. The read logic is operatively configured to read from the queue in a first manner when no overflow of the queue is detected, and to read from the queue in a second manner when overflow is detected.

Still further, a method of queuing data according to yet another embodiment of the present invention comprises defining a queue having addressable storage locations associated therewith, keeping track of a current count value that corresponds to the total number of data events written to the queue where the current count value is capable of counting an amount that is greater than the number of the addressable storage locations of the queue, keeping track of a write pointer that corresponds to a position in the queue for a write operation thereto, writing new data events to the queue in a re-circulating sequential manner irrespective of whether previously stored data has been read out and for each user associated with the queue, keeping track of a previous count value that corresponds to the count value at the time of a previous access to the queue thereby, and reading from the queue according to a prescribed manner.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a schematic illustration of a queue system according to an embodiment of the present invention;

FIG. 2 is a schematic illustration of a queue system according to another embodiment of the present invention;

FIG. 3 is a schematic illustration of a queue system where a first queue cascades into a second queue according to an embodiment of the present invention;

FIG. 4 is a flow chart illustrating the high level operation of a dispatcher when servicing the request of a user to supply event information from a queue according to an embodiment of the present invention;

FIG. 5 is a schematic illustration of a queue and notification system according to yet another embodiment of the present invention;

FIG. 6 is a flow chart illustrating a process for reading from a queue according to an embodiment of the present invention;

FIG. 7 is a flow chart illustrating a process for reading from a queue in response to the detection of overflow according to an embodiment of the present invention;

FIG. 8 is a flow chart illustrating a process for reading from a queue in response to the detection of overflow according to another embodiment of the present invention;

FIG. 9 is a schematic illustration of an event counter used to store a count of the total number of events written to a queue, wherein certain bits of the counter are characterized by specific functions;

FIG. 10 is a flow chart illustrating a process for modifying event data prior to storing the event data in the queue according to an embodiment of the present invention;

FIG. 11 is a flow chart illustrating a process for reading data from an event queue where the data in the event queue has been modified to include additional information provided by the event queue logic;

FIG. 12 is a block diagram of a replicated shared memory system according to an embodiment of the present invention; and

FIG. 13 is a block diagram of a receiving portion of a network node according to an embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

### System Architecture

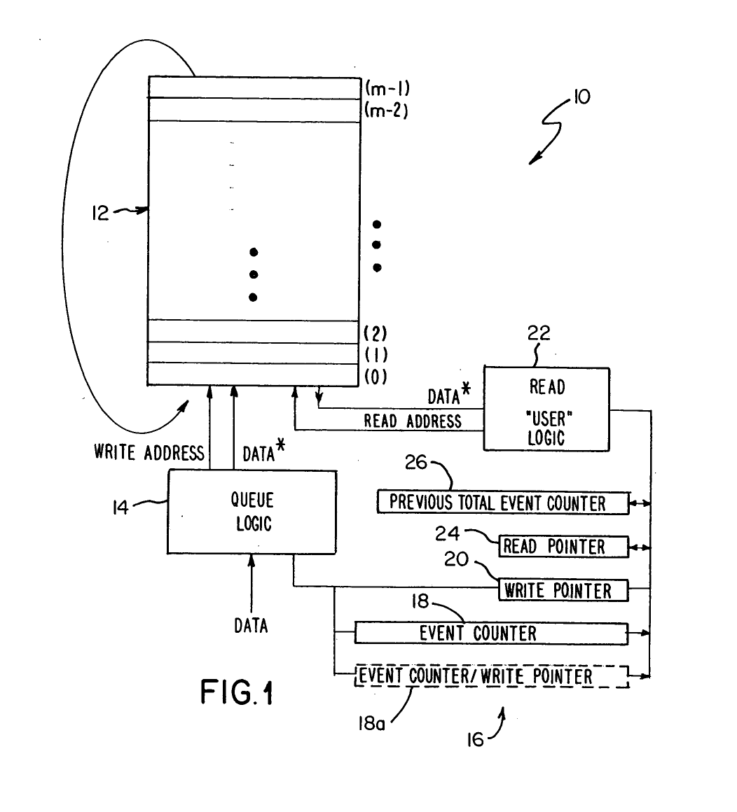

Referring to FIG. 1, a system 10 for queuing information according to an embodiment of the present invention is illustrated. The system 10 comprises generally, a queue 12, queue logic 14, and a set of registers 16 that control access to the queue 12. The term “queue” as used herein is defined broadly to refer to the storage of data, and is not limited to any prescribed manner of storing thereto or reading therefrom. For convenience of discussion herein, the queue is illustrated as an array of sequentially addressable memory locations starting at address (0) through (m−1) for a total address space of (m) storage locations, where m is a positive integer. As a practical matter, it is often desirable to define a fixed bound for the size of each individually addressable storage location. It is also often desirable to define a bound on the number of addressable storage locations allocated to the queue. However, the present invention is not limited in any such regard. Rather, any parameters of the queue 12 may be fixed or dynamically scalable as the specific application dictates.

The queue logic 14 provides the operative controls for transferring data into the queue 12. The queue logic 14 is responsible for receiving incoming data from any appropriate source, storing the data in the queue 12, and for maintaining the appropriate control register(s) 16, such as a total event counter 18 and a write pointer 20. The queue logic 14 preferably performs write operations to the queue 12 independently of read operations from the queue 12. Moreover, the queue logic 14 writes to the queue 12 in a re-circulating, sequential, manner as incoming data is received by the queue logic 14. That is, the queue logic 14 will overwrite existing data in the queue 12 with new available data if the queue is full, irrespective of whether the existing queued data has been read out from the queue 12. As such, it can be seen that for a queue 12 having m addressable queue locations, up to the most recent m data events are queued by the system 10.

The control register(s) 16 provide operating information required by the queue logic 14 and/or any processes that may read from the queue 12. As illustrated, from a conceptual view, there are two registers including a total event counter 18 and a write pointer 20. The total event counter 18 characterizes the total number of events that have been written to the queue 12 by the queue logic 14. The write pointer 20 is an index that tracks where in the address space of the queue 12, a new data event is to be stored. For example, the write pointer 20 may point to the next available address of the queue 12 or the position of the most recent write to the queue 12. Alternatively, the write pointer 20 may be an offset to some predetermined memory address. For example, if the queue 12 is defined by memory addresses in the range of 256-512, the system 10 may optionally store a predetermined memory address, 256 in this example, and the write pointer would then be an offset from the predetermined memory address. As such, if the write pointer currently points to the address 100, the system 10 would access the queue 12 at address 256+100 or address 356.

Furthermore, under certain circumstances, it is possible to store the total event counter 18 and the write pointer 20 in the same register to define a counter/write pointer 18a. According to one embodiment of the present invention, the starting address of the queue 12, which can be conceptualized as either a literal address or an offset to another memory address, is selected to be (0) and the size of the address space (number of addressable locations), denoted m, is selected to satisfy the equation:
size m=2ⁿ
where n is a positive integer. For example, if n is equal to 8, then the size of the address space m=256. Because the address space starts at address (0), the queue address range is 0-255, and can be tracked using the lowest order n bits (8 bits in this illustration) of the total event counter 18. The total event counter 18 is thus selected to be able to hold a count significantly higher than m (256 in this illustration). For example, by allowing the count value stored in the total event counter 18 to be represented as a thirty two bit word, approximately 4.3 billion writes to the queue 12 can occur before the total event counter 18 overflows. Note that as the counter is incremented, the lowest order 8 bits circularly count through a cycle of 0-255. On the 256^{th} write to the total event counter 18, the lowest order 8 bits of the count roll back to zero. Where the write pointer 20 is encoded into the lowest order n bits of the total event counter 18, the system 10 does not need to maintain a separate physical register for the write pointer 20. Under this arrangement, the queue logic 14 writes to the total event counter 18 to update a count stored therein, and the queue logic 14 reads (at least the lowest order n bits) from the total event counter 18 to determine the next write position in the queue 12.

As pointed out above, the queue logic 14 will continue to write event data to the queue 12 as new data becomes available in a sequential, re-circulating manner. In the event that the queue 12 is full, the new data will replace older data irrespective of whether the older data has been read out from the queue 12. This process ensures that the queue logic 14 will not typically lose data received thereby for storage in the queue 12. If data is lost, it is generally due to a failure to read from the queue 12 before previous data is overwritten by newer data. In that regard, it is typically desirous that the write operations receive preference should read and write operations attempt to access the same address location in the queue 12. Moreover, where the queue 12 is implemented in hardware, such as using dual port memory, certain implementations allow the designer to establish priorities between read and write, and the hardware will automatically handle read/write arbitration. In other instances, a separate arbitration and/or snoop function may be implemented. For example, the queue 12 may be configured such that write operations receive priority over read operations. Moreover, the system may not acknowledge that the read data is valid until a snoop or check is made to determine whether a write operation has occurred during the read operation at the specified read address.

The data written to the queue 12 may be a verbatim transfer of the data received by the queue logic 14, or the data written to the queue 12 may include a modified version of the incoming data, i.e., the queue logic 14 may transform the incoming data and/or merge additional information to the incoming data. For example, in one application, the queuing system 10 can be used as a network interrupt queue where the queue 12 holds interrupt vectors or other user defined data. Before storing the network vectors to the queue 12, the queue logic 14 may merge a time stamp or other useful information to the vector. Such will be described in greater detail later herein.

According to an embodiment of the present invention, the queue logic 14 can trigger an interrupt or other signal to a user 22 to communicate the arrival of new data to the queue 12. Depending upon the application however, the interrupt signal may not be necessary, for example, where the user 22 periodically polls for new data. As used herein, the term “user” can refer to hardware, software or any combination of logic thereof that reads from the queue or for which queued data is intended. For example, a particular user may comprise dedicated hardware, a processor, software, software agent, process, application, group of applications or any other processing logic.

The user 22 extracts information from the queue 12 by reading therefrom according to any desired reading scheme. According to one embodiment of the present invention, a user 22 maintains and updates a read pointer 24 in response to accesses to the queue 12. The read pointer 24 is not required from a processing perspective, however, a read pointer 24 can be used for numerous practical purposes as will be explained in greater detail herein. The read pointer 24 is preferably stored or otherwise maintained by the user 22 and not by the queue logic 14. Moreover, the read pointer 24 may be stored in any storage location accessible by the user 22. As pointed out above, writes to the queue 12 are typically handled independently of reads therefrom. Accordingly, reads from the queue 12 are typically not destructive. That is, the same queue address location can be read multiple times by the same or different user.

Comparatively, a read out from a typical FIFO is considered destructive because after each read from the FIFO, the FIFO logic automatically updates the read pointer, which means that a subsequent user cannot also read from a previously read address in the FIFO. Moreover, unlike a traditional FIFO where reads from the queue must occur in a temporally organized list sequential manner, the user 22 can implement any steering logic to navigate the queue 12 to extract data therefrom. For example, the user 22 may attempt to extract the most recently added data or otherwise prioritize the data in the queue 12 according to user needs.

In addition to the read pointer 24, it may be desirable for the user 22 to maintain a previous event counter 26. The previous event counter 26 represents the state of the total event counter 18 upon a previous instance of the user 22 accessing the queue 12. Use of the previous event counter 26 will be described in greater detail herein. Also, if the write pointer 20 is encoded into the lowest order n bits of the total event counter 18 such as the counter/write pointer 18a and the previous event counter 26 is maintained, it can be seen that the user 22 need not maintain a separate read pointer 24 in certain applications. For example, if the write pointer 20 of the current total event counter 18 points to the next available queue address location, then the lowest order n bits in the previous event counter 26 can be conceptualized as a read pointer, because the lowest order n bits of the previous event counter point to the first data event written to the queue 12 since the previous read by the user 22.

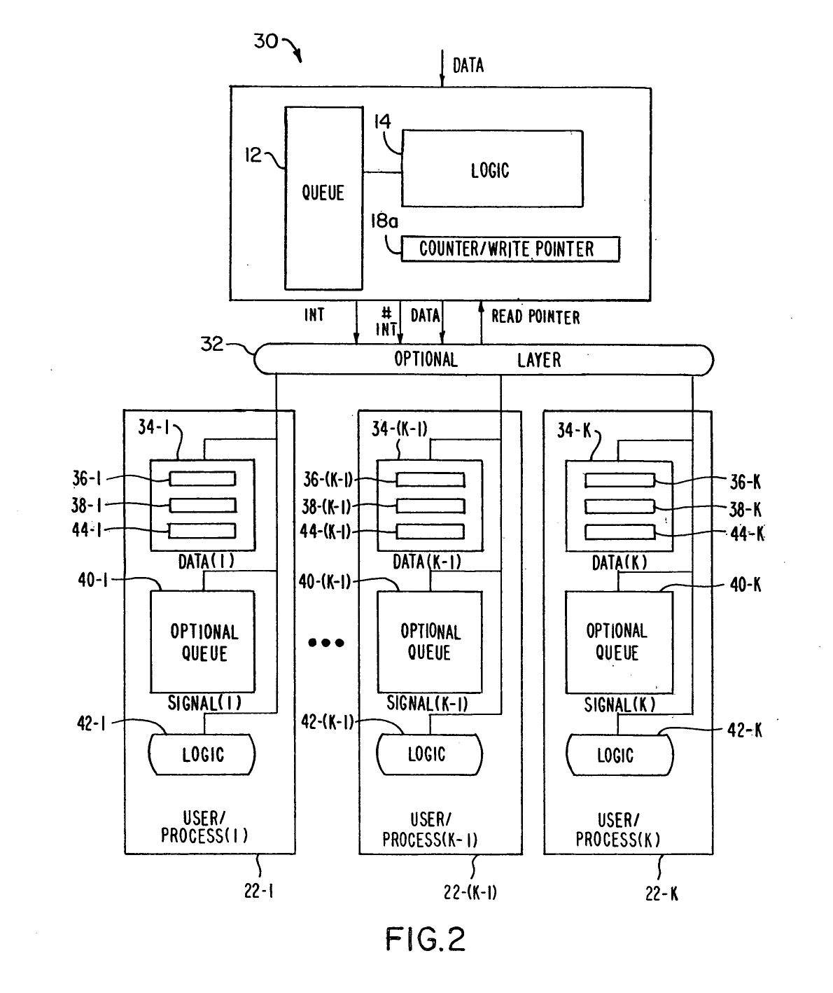

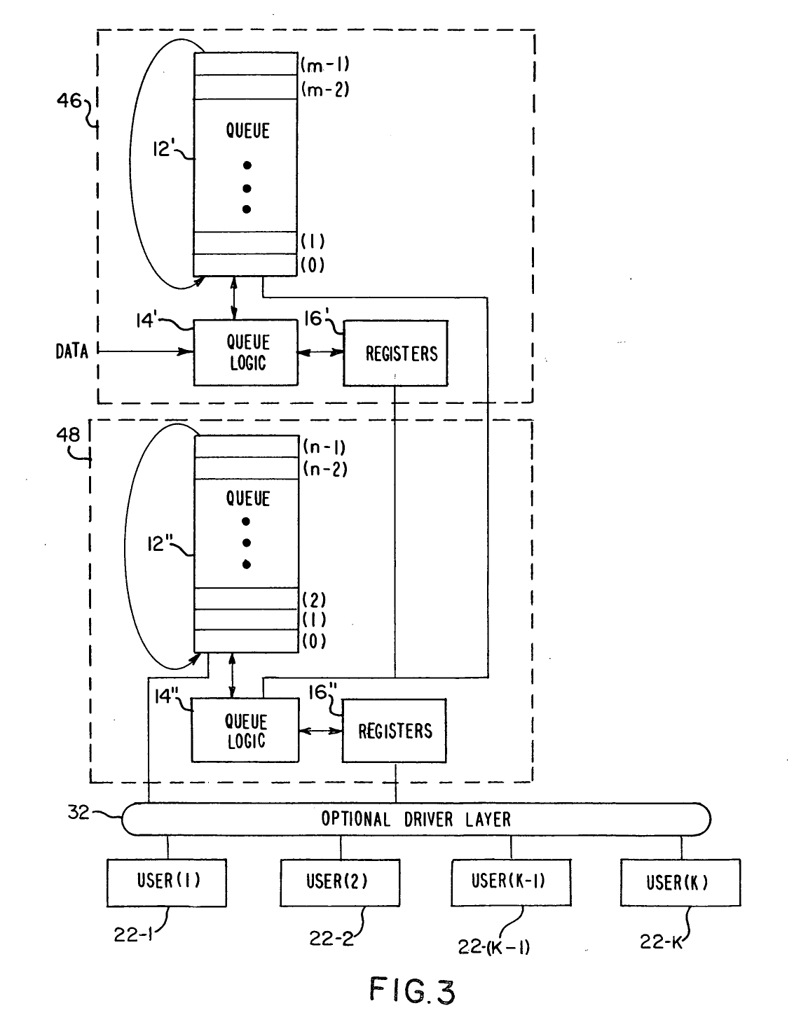

The system 10 may be located in a single instance of hardware or software, or combination thereof. Moreover, the system 10 may be distributed across interconnected, communicably coupled components. Also, the present invention is not limited to the interaction between one queue and one user. Rather, any combination of queues and users implemented in any combination of hardware and software can be combined as the specific application dictates. For example, a system may include one queue that services multiple users or partitioned class of users as is illustrated in FIGS. 2 and 3.

Referring to FIG. 2, a queuing system 30 according to another embodiment of the present invention is illustrated. As illustrated, the queuing system 30 includes a queue 12, queue logic 14 and a counter/write pointer 18a as described above with reference to FIG. 1. Moreover, the system 30 includes multiple users 22 operatively configured to communicate with the queue 12. In practice, the application will dictate the actual number of users. As such, the specification herein uses the reference numeral 22 to refer to users generally. However, reference to a particular user shall be denoted with an extension, e.g. 22-1 through 22-K where k is a positive integer. Moreover, each user 22-1 through 22-K may interact, process and store different types and amounts of data depending upon the particular application(s) associated with that user. Each user 22-1 through 22-K further need not include the same features or perform the same functions as the remainder of the users. As such, the remainder of the discussion herein will refer to aspects associated with the users 22 in terms of reference numbers generally, and add an extension only when referring to a particular aspect of a select one of the users 22.

The present invention however, is not limited to any particular number of users or type of users. An optional interface 32 may also be provided to serve as an intermediate between the users 22 and the queue 12. For example, upon some predetermined condition, such as the receipt of new data in the queue 12, the queue logic 14 sends a signal, e.g., an interrupt, to the intermediate interface 32 indicating that new data is available from the queue 12. Alternatively, the intermediate interface 32 could implement a periodic polling scheme.

The queue logic 14 may also pass additional useful information to the interface 32. For example, the queue logic 14 may pass along the number of new data events in the queue 12. The interface 32 can then take the appropriate action based upon the information received from the queue logic 14. In one instance, the interface 32 may service a select number of users 22-1 through 22-K. The data distributed by the interface 32 to each of the users 22-1 through 22-K can be mutually exclusive, or the data can be shared between two or more users. Each user includes associated registers 34 to keep track of data received from the interface 32. For example, each user 22 may include a previous event counter 36, such as the previous event counter 26 discussed with reference to FIG. 1, that tracks the value of the counter/write pointer 18a at the time of that user's most previous access of the queue 12. Each user 22 may also keep track of a unique read pointer 38, such as the read pointer 24 discussed with reference to FIG. 1, for tracking that user's read operations in the queue 12. For example, the read pointer 38 is communicated to the interface 32, and the interface 32 forwards this information to the queue 12 for data retrieval for that user.

Readout times available to each user 22-1 through 22-K to read from the queue 12 can vary due to any number of factors. For example, read out time may be application specified. Alternatively, the read out time may be allocated by an operating system scheduler that allocates interrupt time based upon available system assets, active program requirements, or other processing scheme. Also, the users 22 do not usually know, and cannot typically control the rate at which data is being added to the queue 12. As such, according to an embodiment of the present invention, each user 22-1 through 22-K determines the manner in which data events are read from the queue 12 on their behalf. For example, one or more of the users 22-1 through 22-K can process data as it is received from the interface 32. Alternatively, one or more of the users 22-1 through 22-K may include a user queue 40 for holding the data provided by the interface 32 for subsequent processing, as well as queue logic 42 for controlling the associated user queue 40. Under such an arrangement, registers to manage the associated user queue 40 may be provided. For example, the registers 34 many include an associated counter/write pointer 44, such as the counter/write pointer 18 as described with reference to FIG. 1. Moreover, the user queues 40, the user queue logic 42 and registers 34 can be implemented in a manner similar to the system 10 discussed with reference to FIG. 1, and can be conceptualized as a system where a first queue (queue 12 as illustrated) cascades into one or more second queues (a select one of the user queues 40).

Notably, the data transferred between the queue 12 and the interface 32 need not be identical to the data received by the queue logic 14. Rather, the queue logic 14 may modify the data or merge additional data thereto as described more fully herein. Likewise, the interface 32 may also manipulate the data received thereby prior to passing the data off to a specific user 22. The interface 32 may be implemented as a software device such as a device driver, a hardware controller, an abstraction layer (hardware or software) or other arbitration logic that accesses the queue 12 on behalf of one or more users 22 and/or decides which user 22-1 through 22-K gets access to the queue 12. The interface 32 may be also be a combination of hardware or software. Moreover, the interface 32 may not be necessary where each of the various users 22 can communicate with the queue 12.

As an example, the interface 32 may be implemented as an interrupt dispatcher for a queuing system where the data in the queue 12 comprises network interrupts or other network node communications. The dispatcher may be able to filter interrupts, dispatch provided interrupt handlers appropriately, utilize an intermediated interrupt queue in system memory and control the callback of user-supplied interrupt handlers based on an appropriate interface mechanism such as a signal-deferred procedure call. Moreover, the dispatcher could include its own priority handling if desired. For example, where the events comprise network interrupts, a dispatcher may try to sort the data and provide the appropriate data network interrupt types to the most appropriate user.

Referring to FIG. 3, another embodiment of the present invention is illustrated where a first queue is cascaded into a second queue, and the second queue is used to service one or more users. Such a system can be implemented by the dispatcher discussed above, or any other combination of hardware and/or software. Essentially, a first queuing system 46 comprises a first queue 12′ having m total address locations, first queue logic 14′ and first queue registers 16′. A second queuing system 48 comprises a second queue 12″ having n total address locations, second queue logic 14″ and second queue registers 16″. The first and second queues 12′ and 12″ can be implemented as described in a manner analogous to queue 12 discussed with reference to FIG. 1. Likewise, first and second queue logic 14′ and 14″ as well as registers 16′ and 16″ can be implemented in a manner analogous to queue logic 14 and registers 16 discussed with reference to FIG. 1.

Essentially, the second queuing system 48 copies data events read out from the first queue 12′ to the second queue 12″. Notably, the first and second queues 12′ and 12″ need not have the same number of address locations. An optional interface 32 may be used to couple users 22 to the second queuing system 48, or the users 22 may directly interface with the second queuing system 48 as described more fully with respect to FIG. 2. The cascaded approach illustrated in FIG. 3 may be beneficial, for example, where the first queuing system is implemented in hardware and the size of the queue 12′ implemented in hardware is insufficient to service one of more users 22 due to timing constraints imposed by the frequency of new events and their associated retrieval. Under this arrangement, the second queuing system 48 may be implemented in software, and have a queue size that is sufficient to meet the needs of the associated users 22.

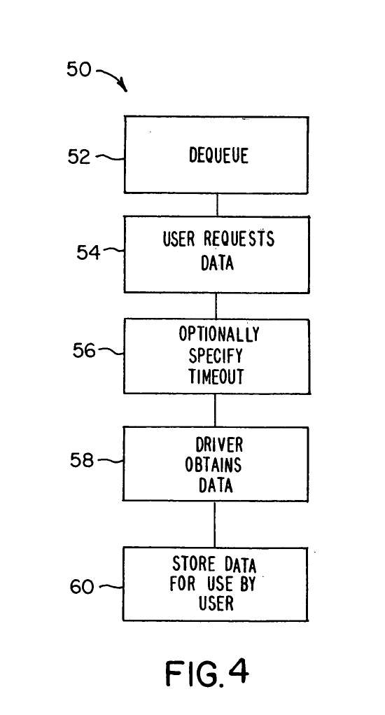

Referring to FIG. 4, a simplified method 50 of implementing a dispatcher is illustrated. The dispatcher dequeues at 52, interrupts from a queue such as queue 12 in FIG. 2. A user makes a call to the dispatcher with how many interrupts the user is interested in at 54. The user may also optionally specify a timeout threshold at 56. The timeout threshold identifies how long the dispatcher is to spend attempting to service the user's request for information from the queue. For example, the timeout threshold could be set to 0 instructing the dispatcher to return from the queue immediately without waiting for the arrival of new events. The timeout threshold may also be conceptualized as a user specified time period that defines how long a user can wait for data. For example, the user may only have 10 milliseconds to obtain event data from the queue before the user must return to processing other tasks. The dispatcher obtains event data in the time period specified by the timeout threshold at 58, and the dispatcher delivers the event data collected to the user at 60.

Assume that a user requests 100 data events, specifies a timeout threshold of 10 milliseconds, and further specifies a predetermined range of storage locations (such as a user queue 42 discussed with reference to FIG. 2) where the new event data is to be placed. The call from the user to the dispatcher will return when the 100 events have been obtained, or the timeout threshold has expired. If the timeout threshold is met, e.g. where the dispatcher cannot deliver the requested number of data events in the allotted time, then the dispatcher may simply deliver that event data available thereto and provide the user with an indication of how many data events were copied into the identified storage locations. In the above example, no filtering of event data based on content is performed, however, such may be implemented in practice. Alternatively, the user can simply throw away the undesired events provided by the dispatcher. The later approach may maintain optimal system speed in certain applications however.

Referring back to FIG. 2, it can be seen that each user 22 keeps track of their own read pointer 38 and/or previous event counter 36. Further, each user 22 can access the queue 12 at different rates. Accordingly, the queue 12 may be in a state of overflow for a first user, e.g. 22-1, but not for a second user, e.g. 22-2 because a second user 22-2 could have read more information out of the queue 12 than the first user 22-1.

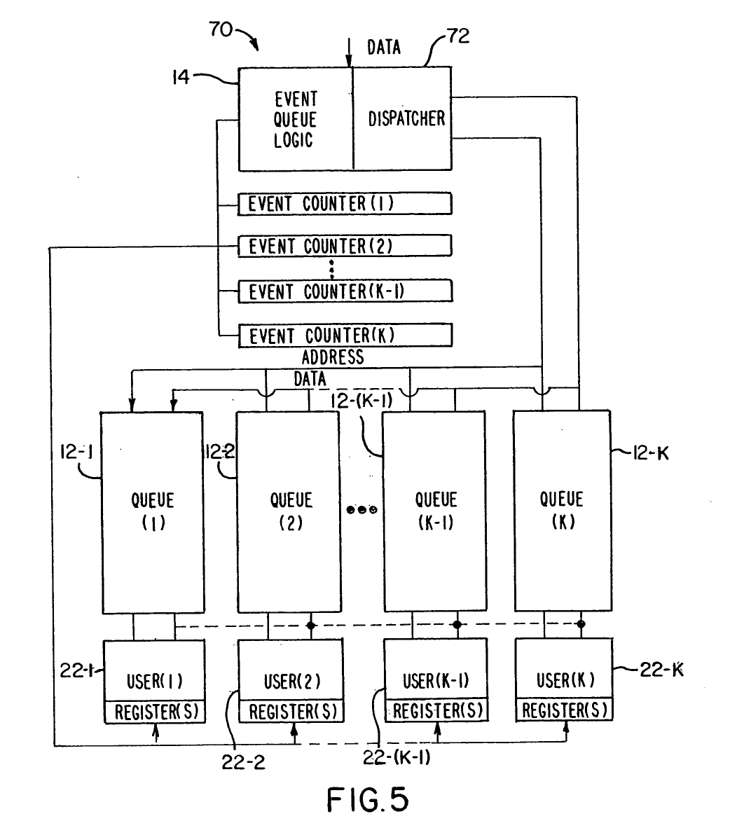

Also, in addition to having a dispatcher to handle extraction of information from the queue 12, the queue logic 14 may itself include a dispatch manager that pre-screens the data before it is even inserted into the queue 12. Referring to FIG. 5, a queuing system 70 according to another embodiment of the present invention is illustrated. The system 70 is similar to the system 10 described with reference to FIG. 1 and as such, like structure will be represented by like reference numerals. As shown, the queue logic 14 is responsible for maintaining an arbitrary number of queues 12-1 through 12-K. The control logic 14 includes a dispatcher 72 that routes the incoming data to appropriate ones of the queues 12-1 through 12-K. For example, the system may receive different types of data that the control logic 14 can classify and store in different ones of the queues 12-1 through 12K. Each queue 12-1 through 12-K may support one or more users 22-1 through 22-K. However, there need not be a direct correspondence between the number of users 22 and the number of queues 12. Moreover, each user 22-1 through 22-K can access more than one queue 12, as schematically indicated by the dashed line between the users 22 and the queues 12.

### Reading from the Queue

The manner in which data is read out of the queue can vary depending upon the specific application requirements. However, the non-destructive and random access nature of the read operations enabled according to various embodiments of the present invention, allows a tremendous degree of flexibility to a systems designer. For example, a FIFO refuses entry of new data when overflow has occurred, thus a user has no chance of reading the lost data. In the various embodiments of the present invention, new data is written to the queue in a circular pattern to replace the relatively old data in favor of new data under the assumption that the newer data is more important from the user's perspective. Accordingly, the queue itself may never lose data. However, if data in the queue is overwritten, overflow is said to have occurred, because the overwritten data is lost to the user application that missed the opportunity to read the lost data while it was in the queue.

Referring back to FIG. 1, while read operations can be carried out independently of the detection of overflow of the queue 12, powerful and efficient responses to overflow can be implemented. For example, in non-overflow circumstances, e.g. where the difference between the current total event counter 18 and the previous event counter 26 at the time of the last read is less than the total number of addresses (m) in the queue 12, then the queue 12 can be accessed in a first manner, such as similar to an ordinary FIFO or LIFO. However, unlike a FIFO or LIFO, the same or another user 22 can read an address location that has been previously read. For example, a multi-threaded application or debugging application may be able to leverage the random access of the queue 12 to perform enhanced performance tasks. Also, a semaphore is not required to service multiple users because there are no side effects of read operations on the status of the queue 12. The present invention is also particularly well suited to address issues of queue overflow, especially where it is desirable to preserve data in a manner inconsistent with the current manner in which data is being read out of the queue 12. For example, the user may wish to obtain the most recent relevant data in view of queue overflow.

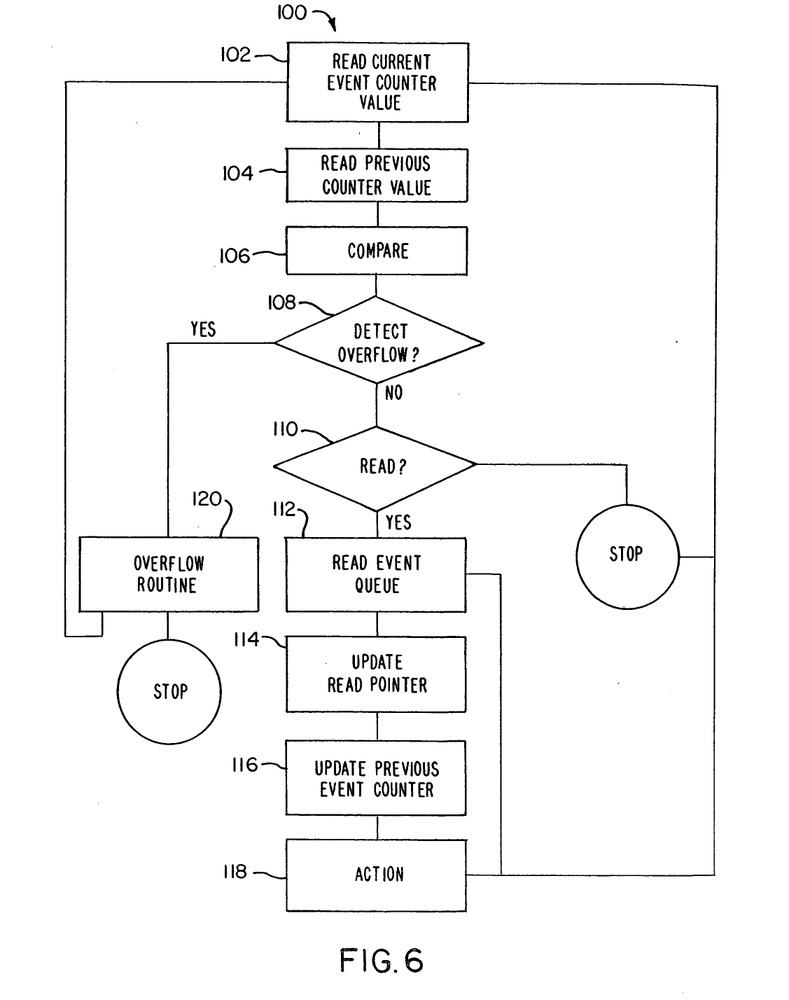

Referring to FIG. 6, a flow chart 100 illustrates one method of reading data from the queue. Initially, the total event counter is read at 102 to determine the current total number of events written into the queue. The value of the previously saved instance of the total event counter is read at 104 to determine the total number of events at the time of the last access to the queue. The prior total event count and the current total event count are compared at 106. An optional decision may be made at 108 whether overflow has occurred. This step is not necessary, but does allow the option of altering the manner in which data is read from an overflowed queue. Overflow may be detected in a number of ways. For example, overflow may be determined if the difference between the current total event counter and a previously saved instance of the total event counter is greater than the size (number of addressable locations) of the queue.

If no overflow is detected, a decision is made whether to read from the queue at 110. For example, if the prior total event count and the current total event count are equal, then there is no new data to read, and the process may be stopped. This check may be useful, for example, where the user polls the queue system for new data or where the prior total event count has been updated pursuant to a subsequent read operation. Also, a user may have a limited time period to read from the queue. The time period may be fixed, or variable. However, there may be sufficient time to generate multiple reads from the queue. As such, a check can be made whether there is enough time left for the user to perform another queue read operation.

If it is ok to read from the queue, the queue is read in a first manner, for example, based upon the current read pointer at 112 and the read pointer is updated at 114. Additionally, the previous event counter is updated at 116, and an appropriate action is taken at 118. The action taken can be any desired action, and will likely depend upon the specific application. For example, the user may simply retrieve the data and store it in a local queue for subsequent processing. Alternatively, some further processing may occur. After reading from the queue, the user may stop or determine whether another read from the queue is necessary. In this regard, a number of options are possible.

The user may simply read the next address without first updating a check on the total event counter to see if new data has become available during the previous read access. For example, if the user knows that there are 20 new interrupts and further knows that there is sufficient time to read 10, the user may opt to simply read out the next 10 interrupts. On the other hand, the user may want to periodically check the current total event counter such as to make sure no overflow has occurred, or that the proper data events are being read out.

In the event that overflow is detected at 108, data may be read from the queue in a second manner at 120. When overflow occurs, data is lost to the user. However, the user may establish its own manner to deal with the lost data. The exact approach will vary from user to user, dependent possibly, on the nature of the data. For instance, sometimes, the most recent data is the most important. Other times, the oldest data is the most important. Still further, a user may want to prioritize the existing data in the queue based upon a non-chronological manner, cognizant of the fact that, at any time, additional data may enter the queue.

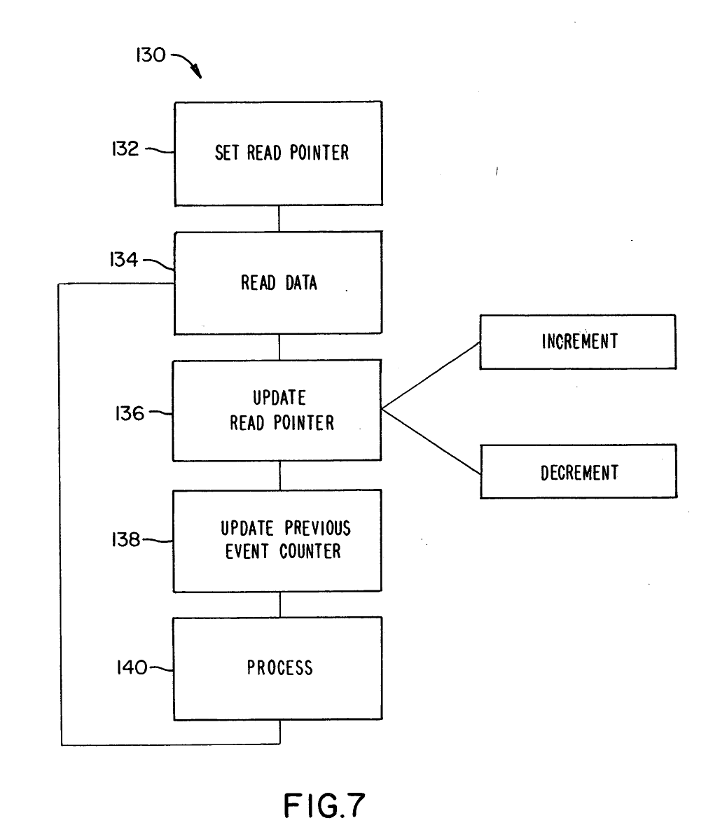

Referring to FIG. 7, a flow chart 130 illustrates one exemplary manner in which a queue read operation can be modified based upon the detection of overflow. The described manner assumes that overflow has already been detected, such as at 108 in FIG. 6. Essentially, the current read pointer is ignored and set to some new value at 132. For example, the read pointer may be updated to the address of the most recent data written to the queue. Where the write pointer points to the next available queue address, the read pointer is set to write pointer −1. The data is read out according to the modified read pointer at 134, the read pointer is updated at 136 the previous total event counter is updated at 138, and the extracted data is processed at 140. At this point, the user can take any desired next action. For example, the user may stop processing data from the queue, continue to read from the queue according to the determined second manner, or go back and check the status of the total event counter, such as to return control to the step 102 in FIG. 6. The read pointer can be updated at 136 to track in the same direction as the writing of data to the queue, or the read pointer can be updated so as to update in the opposite direction of the write operation to the queue. Under the later approach, the intent of the read operation is to read out incrementally older pieces of data during a given read cycle.

Alternatively, instead of setting the read pointer to the position of the most recent write at 132, the read pointer can be indexed back from the most recent write position in the queue at 132. For example, the read pointer can be set such that the new read pointer is equal to the most recent write position minus j events where j is a nonnegative integer. There are a number of ways to establish the variable j, but one approach is to select j to satisfy the equation:
j+k=(predicted last write position−updated read pointer)
at the end of the current write cycle where k is the number of new additions to the queue during the read operation. For example, if it is predicted that a given user can read 20 events in a given read cycle, and it is further anticipated that 10 events will be added to the queue (k=10) during the read cycle, then the read pointer is indexed back 10 address locations (=10) from the most recent write address, so that by the time all 20 events are read out, the read pointer should have caught up with the write pointer. After each read from the queue, the read pointer is incremented towards the write pointer.

As yet another approach, if the write counter outpaces the read for each read of the queue, then the read pointer can be readjusted to the most recent write position for each read of the queue. In all of the above described approaches, which are presented for purposes of illustration and not of limitation, it should be observed that it is possible that entries in the queue are skipped over by processing, which may be necessary where the incoming rate of data into the queue exceeds the capacity of the user(s) to remove and process the queued data.

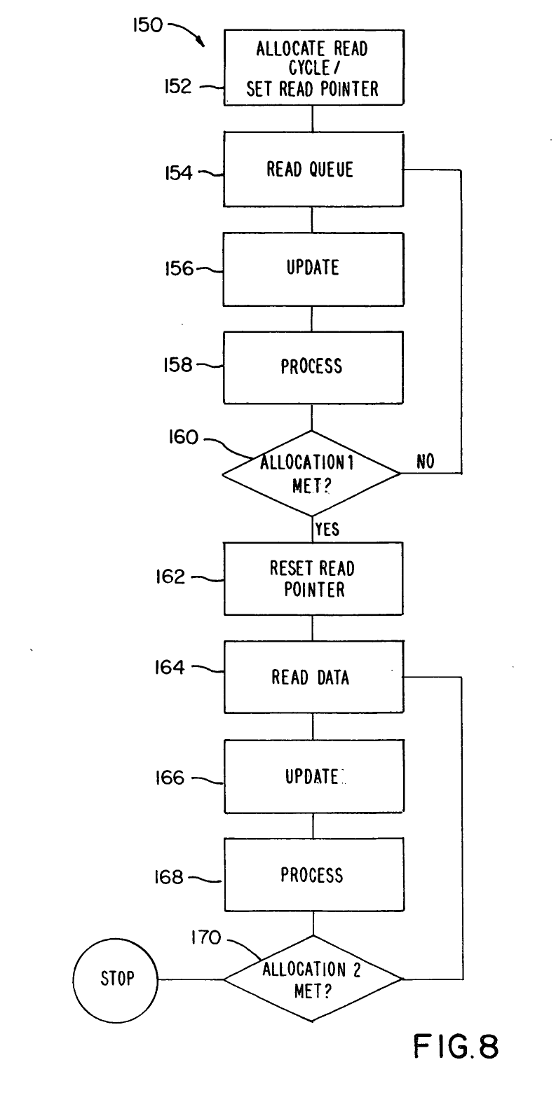

Referring to FIG. 8, a flow chart 150 illustrates an exemplary manner in which a queue read can be modified based upon the detection of overflow according to yet another embodiment of the present invention. The described manner assumes that overflow has already been detected, such as at 108 in FIG. 6. Initially, the user partitions the total read cycle into two partitions at 152. Each partition defines a different approach to reading from the queue. Partitioning can be temporal, such as defining a first partition of the read cycle time to track in the direction opposite to the write pointer, and the second partition of the read cycle time to track in the direction of the write pointer. Alternatively, the partition can be based upon a number of data reads to occur in a first direction, and a number of data reads to occur in a second direction.

The read pointer is also optionally updated to some new position at 152. For example, the read pointer may be updated based upon the location of the last write to the queue. The queue is read at 154 and the read pointer, and optionally the previous event counter are updated at 156. For example, the read pointer may be updated by tracking the read pointer in a direction opposite to the write direction. The data is processed at 158. The user may simply place the data into a second queue for subsequent processing, or the user may take action on the data. A check is then made at 160 to determine whether the first allocated partition has been reached. If not, flow control returns to read from the queue at 154. To process the second partition, the read pointer is updated to some new position at 162. This may be based upon a new read of the counter, or may be based upon the initial read of the counter.

For example, the read pointer can be returned to one position beyond where the overflow process initially started. This of course, assumes that additional events are written to the queue during processing of the first partition of the read cycle. If no new events are expected, then the first partition can begin some index (i) from the current counter. The data is read at 164 and the read pointer and optionally, the previous counter are updated at 166. Next, the data is processed at 168. If the second allocation criterion is met at 170, the process stops, otherwise, a new read of the queue is performed at 164.

### Extensions to the Queuing System

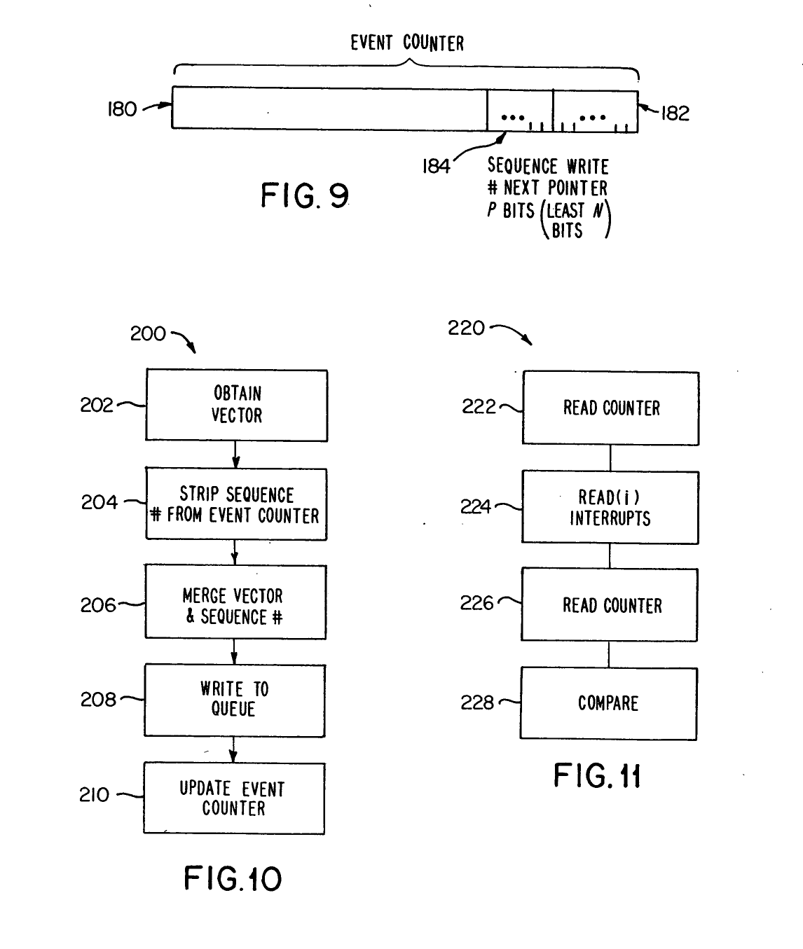

Referring to FIG. 9, a total event counter 180 according to an embodiment of the present invention is illustrated. The total event counter 180 is similar to the total event counter 18 described with reference to FIG. 1. As shown, the lowest order (N) bits are used for a dual purpose i.e., to define the total event count and to track the write pointer 182. Under this approach, the queue size is set to 2^{N} bits. Thus, if the lowest order 8 bits are used as the write pointer 182, the queue is configured to have an address size of 2⁸ (256 addresses) or an address range of 0-255. Where the write pointer 182 is embodied in the N lowest order bits, the remainder (highest order) bits in the total event counter can be thought of from a conceptual standpoint, as a count of the number of times that the queue has been filled or cycled through.

For example, assuming that the counter starts at (0) and that the lowest order 8 bits track the write pointer in a 256 address queue, then the ninth bit of the total event counter will toggle from the value of (0) to the value of (1) when the first piece of data in the queue is overwritten, i.e. when address (0) is written to for the second time. Accordingly, a number of bits (p), which are the bits within the total event counter positioned above the most significant bit of the write pointer bits, can be conceptualized as a sequence counter 184. For example, bits of a 32 bit total event counter 180 can be used as a sequence counter 184. Where the write pointer 182 is the least significant 8 bits, the sequence counter 184 is bits 9-17 of the total event counter 180.

Referring to FIG. 10, a method 200 is provided where the queue logic, such as queue logic 14 discussed with reference to FIG. 1, can merge the sequence counter or sequence number with the next incoming data event and store the entire string in the queue, such as queue 12 discussed above with reference to FIG. 1. The queue logic receives incoming data at 202. The data can be considered a vector of data and can be defined in any manner. The queue logic reads the sequence number from the counter at 204 and merges the sequence number with the vector at 206. The queue logic then stores the vector and the sequence number in the queue at the address specified by the current write pointer at 208, and the logic updates the counter (and thus the write pointer and possibly a sequence counter) at 210. While the sequence number is not a precise time stamp, it is a computationally efficient approach to providing a ballpark range of age to a particular data.

The addition of the sequence number allows intelligent processing of data. For example, as pointed out, it is possible in some environments to generate and queue data significantly faster than the rate at which data can be extracted from the queue. For example, in some distributed network environments, it is possible to generate millions of interrupt data events per second. Accordingly, a queue may overflow one or more times during a read operation. If a user does not continually check the current state of the total event counter, it is possible to read a data record expecting a first data, but actually fetch a second because the expected information was overwritten. A user process now has an alternative to strike a balance between the computational cost of rereading the counter versus maintaining a confidence that the data retrieved from the queue is in fact, the most recent, relevant data.

Referring to FIG. 1, one method 220 of using the sequence numbers is to read the total event counter, such as the total event counter 180 discussed with reference to FIG. 9 at 222. Next, (r) consecutive events are read out of the queue at 224 and the counter is read again at 226. Any necessary comparisons then can occur at 228. The method 220 thus provides a lot of useful information that can be analyzed subsequently to reading from the queue. For example, a comparison of the total event counter readings at 222 and 226 will provide the total number of data events written into the queue during the read operation. Moreover, a comparison of the total event counter at 226 compared to a previously stored total event count can provide a count of the total number of data events written into the queue between successive reads. Still further, the sequence numbers of each of the r data events can be compared. If all of the sequence numbers are the same, then no overflow occurred during the read operation. If the sequence numbers between two compared data events are different, the user can determine the number of times the queue overflowed during the time span of reading the two data events being compared.

### Queuing System in a Distributed Shared Memory Network

A replicated shared memory system is essentially a hardware supported global memory architecture where each node on a network includes a copy (instance) of a common memory space that is replicated across the network. A local write to a memory address within this global memory by any node in a distributed system is automatically replicated and seen in the memory space of each node in the distributed system after a small and predictable delay. Each node is typically linked to the other nodes in a daisy chain ring. Transfer of information is carried out node to node until the information has gone all of the way around the ring. Network interrupts are often used in shared memory networks for inter-nodal synchronization, as an asynchronous notification system between nodes and for signaling between nodes. Network interrupts can also be used for a variety of additional purposes including for example, simulation frame demarcation, indication of a complete data set available for processing, indication of network status such as a new node coming on-line, error indication, and other informative purposes.

Referring to FIG. 12, an example is given where queues according to an embodiment of the present invention are utilized in a shared memory network application. A shared memory network 300 is configured in a ring-based architecture comprising a plurality of nodes 302, 304, 306, 308 on the network 300. In practice, any number of nodes may be on line at any given time. Each node 302, 304, 306, 308 comprises a host system 310 that has at least one central processing unit (CPU) 312, local memory 314 and system bus 316. The host can be, for example, a personal computer, desktop, laptop or other portable computing device. Each node 302, 304, 306, 308 also has a network interface 318. The network interface 318 may be arranged for example, on a network interface card (NIC) that is communicably coupled to the bus 316 of the host system 310.

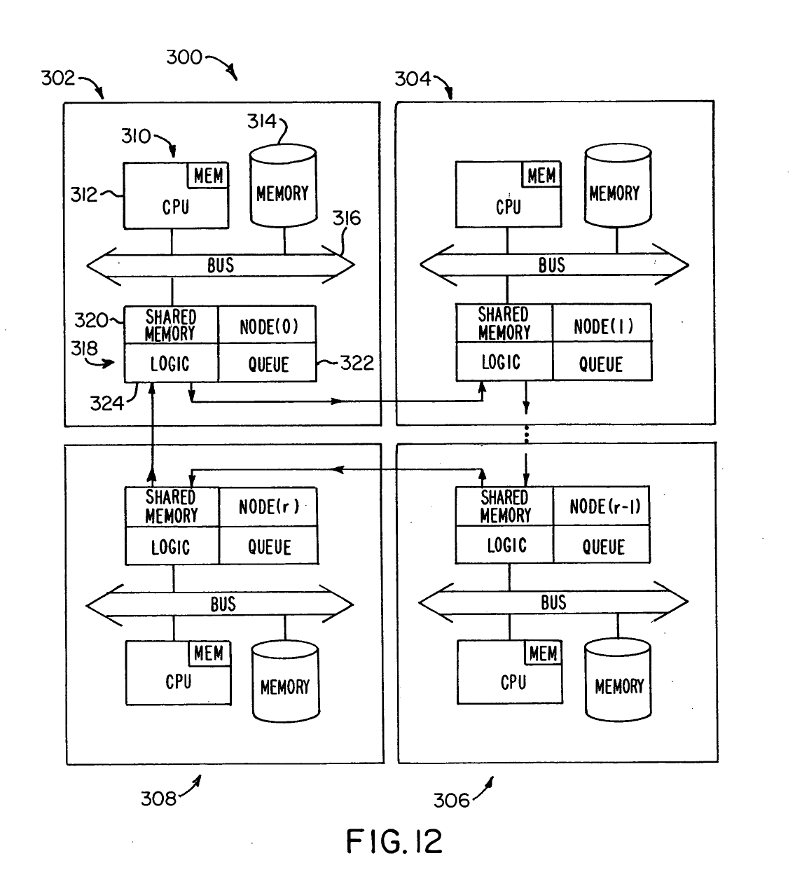

The network interface 318 includes a shared memory 320, a queue 322 and processing logic 324 that includes queue logic. The processing logic 324 provides the necessary functions to maintain the queue 322 and may, in addition, provide other functions related to network processing including, for example, message reception and transmission arbitration, network control, memory management, interrupt handling, error detection and correction, node configuration, and other functions. The processing logic 324 further integrates with a host system 310, or bus specific logic. The network 300 including the queue 322 can be implemented using any system or method discussed, for example, in the preceding FIGS. 1-11.

In this example, each queue 322 may be used to queue network interrupts transmitted between network interfaces 318 of the nodes 302, 304, 306 and 308. The queues 322 can be any combination of hardware or software, and may comprise one queue or more than one queue that is cascaded as described more fully herein. The queue 322 does not impact the operation of network interrupts, so long as an interrupt can be successfully stored in, and retrieved from the queue 322. As such, the exact content of the network interrupts and usage thereof, can be customer or user determined. Moreover, each host system 310 may provide one or more users to access each queue 322 as described more fully above. Still further, each node may support multiple interrupt queues as described more fully herein. For example, each node 302, 304, 306, 308 may assign certain types of network interrupts to specific instances of interrupt queues. Regardless, each user keeps track of their own previous (interrupt) count and read pointer.

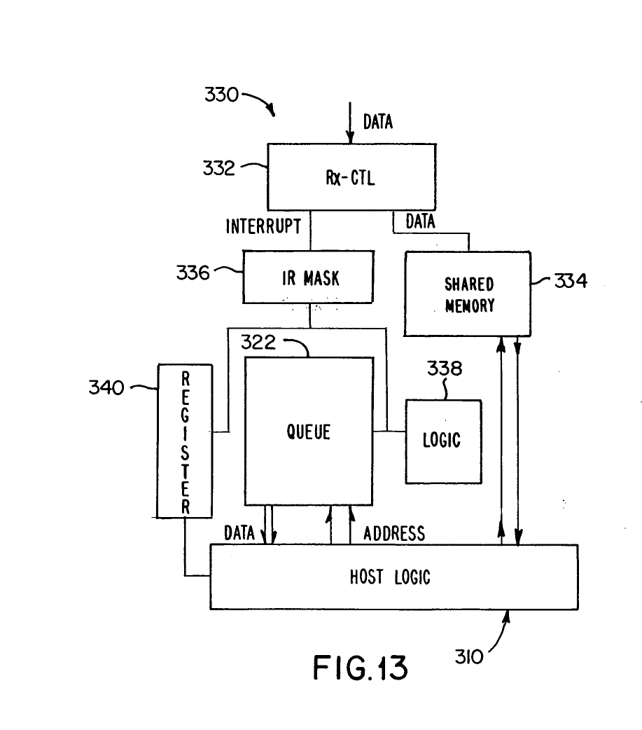

Referring to FIG. 13, a subsection 330 of the network logic 324 shown in FIG. 12 is schematically illustrated. The subsection 330 includes receiver control logic 332 operatively configured to receive data transmitted across the network. The receiver control logic 332 (or some other process logic) determines whether the received data comprises information to be stored in the shared memory, or whether the data comprises a network interrupt. Information for storage is written to the shared memory using shared memory control logic 334. The network interrupt data may first optionally be filtered by an interrupt mask 336. For example, the network node may want to temporarily or permanently turn on or off certain types of network interrupts. The interrupt mask 336 may be implemented in hardware, software of a combination thereof. If the interrupt mask 336 decides to filter the data, it is discarded (although other circuit logic may be required to forward the information onto another node). If the interrupt mask 336 does not filter out the network interrupt, the network interrupt is placed into the interrupt queue 322. As such, only network interrupts that have been enabled and received are stored in the interrupt queue 322.

Referring to FIGS. 12 and 13 generally, the queue logic 338 updates the queue 322 and registers 340, such as a total event counter/write pointer as described more fully herein. The queue logic 322 may also optionally merge a sequence number from the total event counter or other information with the network interrupts as they are stored in the queue 322. In this embodiment of the present invention, the queue logic 338 does not prioritize the interrupt data, but rather queues the interrupt data chronologically based upon when the interrupt data is received past the interrupt mask 336. The interrupt queue 322 can be further accessed by the host system 310, typically triggered by the host microprocessor via an appropriately designed device driver or user level software.

The network logic 324 may also have a programmable interrupt controller (which a device driver run by the host system 310 can program) to interrupt the host system 310 when the number of interrupts entered into the queue 322 exceeds a particular value. The driver or other host system user could also poll the network interface 318 at its leisure to see if any new interrupts are present.

The driver or other host system user maintains the latest count of the network interrupts (initially zero) in an interrupt counter. When the driver is interrupted, the interrupt counter is read to see how many new interrupts have arrived. The last interrupt count (truncated to the lowest order n bits) is the address where new interrupts (since last servicing) have started. The new interrupt count (truncated to the lowest order n bits) is the last location where interrupts are stored. Note that these values may be changing while the interrupts are being serviced and new network interrupts may be arriving. If the difference between the old interrupt count and the new interrupt count is less than the queue size, then no interrupts have been lost since last service. A variety of techniques based upon the above are possible. One example is as follows:

Since multiple applications running on the host system 310 could desire notification of interrupts (each with their own area of interest), the driver could keep an area of memory dedicated for each application interested in network interrupts from the queue 322. In addition, the driver can keep track of applicable information for each process, such as which interrupt a particular process is interested in, pointer to memory of software interrupt queue for this process, number of interrupts written for this process, or process identification. The device driver would then copy the data to the respective areas for each process based upon the type of interrupt and which processes were interested in this data. The device driver then updates the process's interrupt counter and then signals the process that the new data is available.

Accordingly, the device driver can act as a dispatch manager by reading the data from the network interface 318 and keep a separate software queue allocated per process. The device driver would perform the same function that the hardware performed (filtering interrupts based on content desired, incrementing the write pointer, and keeping track of the number of interrupts but on queues permitted in the system memory and on a per-process basis). The user level processes would process their associated software queue in the same manner that the device driver processed the hardware interrupt queue such as is set out in greater detail in the discussion of FIGS. 1-4. Note also that in environments where each node of a system is implemented on a separate network interface card, the device driver can service multiple network interface cards in the same way that it handles a single network interface card.

Having described the invention in detail and by reference to preferred embodiments thereof, it will be apparent that modifications and variations are possible without departing from the scope of the invention defined in the appended claims.

What is claimed is:

1. A queuing system comprising:
a queue having a plurality of addressable storage locations associated therewith;
queue logic to control write operations to said queue, said queue logic operatively configured to write data events to said queue in a re-circulating sequential manner irrespective of whether previously stored data has been read out;
a current event counter updated by said queue logic to keep track of a count value that corresponds to the total number of data events written to said queue, said current event counter capable of counting an amount that is greater than said plurality of addressable storage locations;
read logic operatively configured to read data events from said queue according to a prescribed manner, said read logic further communicably coupled to said current event counter for reading said count value stored therein; and
a read pointer controlled by said read logic that relates to where in said queue data is to be read from said queue, wherein said read logic can read from said queue based upon said read pointer independently of write operations to said queue.

2. The queuing system according to claim 1, further comprising a previous event counter that is controlled by said read logic that relates to a previous value of said current event counter at the time of a previous read operation on said queue by said read logic.

3. The queuing system according to claim 2, wherein said read logic is further operatively configured to determine whether data has been lost in the queue due to queue overflow based upon a comparison of a current value of said current event counter and said previous value stored in said previous event counter.

4. The queuing system according to claim 2, wherein said read logic is further operatively configured to perform read operations according to a first prescribed manner when no queue overflow is detected, and said read logic performs read operations from said queue according to a second prescribed manner when queue overflow is detected.

5. The queuing system according to claim 2, wherein said read pointer is derived directly from a predetermined number of the lowest order bits of said previous event counter.

6. The queuing system according to claim 1, wherein a write pointer is derived directly from a predetermined number of the lowest order bits of said current event counter.

7. The queuing system according to claim 1, wherein said queue logic merges a sequence number derived from said count value of said current event counter with each data event stored in said queue.

8. The queuing system according to claim 1, wherein said user communicates with said queue through an intermediate interface.

9. The queuing system according to claim 1, wherein said read logic is associated with a plurality of users, each user comprising:
read logic operatively configured to read information from said queue according to a prescribed manner, said read logic further communicably coupled to said current event counter for reading said count value stored therein; and
a read pointer updated by said read logic that relates to where in said queue data is to be read from said queue, wherein said read logic can read from said queue based upon said read pointer independently of write operations to said queue, wherein said read pointer and read logic of each user operates independently of one another.

10. The queuing system according to claim 1, wherein said read logic further cascades data events read from said queue into a local queue for subsequent processing.

11. A queuing system comprising:
a queue having a predetermined number of addressable storage locations;
an event counter operatively configured to sequentially update a count value stored therein each time a data event is written into said queue, said count value capable of storing a maximum count that exceeds said predetermined number of addresses;
a write pointer that is derived from said count value stored in said event counter from which a select addressable storage location of said queue can be determined for temporarily storing each data event that is to be queued;
a read pointer from which a desired addressable storage location of said queue can be identified for a read operation;
queue logic communicably coupled to said queue, said event counter, and said write pointer to control writing new data events to said queue; and
read logic coupled to said queue, said event counter and said read pointer, said read logic operatively configured to read from said queue in a first manner when no overflow of said queue is detected, and to read from said queue in a second manner when overflow of said queue is detected.

12. The queuing system according to claim 11, wherein said write pointer is encoded into said event counter.

13. The queuing system according to claim 11, wherein said predetermined number of addresses of said queue is defined by the expression: m=2n, where m is the number of addresses, and n is a positive integer.

14. The queuing system according to claim 13, wherein said write pointer is defined by the lowest n bits of said event counter.

15. The queuing system according to claim 14, wherein a portion of said count value is stored in said queue with each data event written thereto, said portion defined by at least one bit of said count value starting at the n+1 bit.

16. The queuing system according to claim 11, wherein each read from the queue is nondestructive, and each write to the queue overwrites the current content of the storage location addressed by the write pointer.

17. The queuing system according to claim 11, wherein said first manner of reading from said queue comprises reading from said queue in a first in, first out manner such that a list sequential read follows a temporal aging from the oldest to the newest events in said queue and said second manner of reading from said queue comprises reading from said queue in a manner that reads the most recent events written to the queue first.

18. The queuing system according to claim 11, wherein said second manner of reading from said queue comprises setting said read pointer to said write pointer prior to initiating a read operation.

19. The queuing system according to claim 11, wherein said second manner of reading from said queue comprises reading in a first direction for a predetermined portion of a read cycle, and reading in a second direction for a remainder portion of said read cycle.

20. The queuing system according to claim 11, wherein said second manner of reading from said queue comprises setting said read pointer to a position a predetermined number of addresses in a direction opposite to said write pointer, and beginning a read cycle wherein a plurality of data events are read in the direction of write operations to said queue.

21. The queuing system according to claim 11, wherein said read logic further comprises a previous event counter that keeps track of a representation of said count value of said event counter at the time of a previous read operation.

22. The queuing system according to claim 21, wherein said read counter is derived from the lowest order bits of said previous event counter.

23. A method of queuing data comprising:
defining a queue having addressable storage locations associated therewith;
keeping track of a current count value that corresponds to the total number of data events written to said queue, said current count value capable of counting an amount that is greater than the number of said addressable storage locations;
keeping track of a write pointer that corresponds to a position in said queue for a write operation thereto;
writing data events to said queue in a re-circulating sequential manner irrespective of whether previously stored data has been read out; and
for each user associated with said queue:
keeping track of a previous count value that corresponds to said current count value at the time of a previous access to said queue thereby; and
reading from said queue according to a prescribed manner.

24. The method according to claim 23, wherein at least one user reads from said queue according to a first prescribed manner when no queue overflow has been detected, and reads from said queue according to a second prescribed manner when overflow has been detected.

25. The method according to claim 24, wherein queue overflow is detected if the difference between said current count value and said previous count value is greater than a total number of said addressable storage locations.

26. The method according to claim 24, wherein a select user requests data events from said queue comprising:
specifying a total number of requested data events;
specifying a timeout period that represents the maximum amount of time said user is willing to wait for said data events accessing said queue to obtain said data events; and
queuing any extracted data events in a local queue accessible by said user.

27. The method according to claim 24, wherein a select user reads from said queue comprising:
reading said current count value;
reading said previous count value;
comparing said current count value to said previous count value to determine whether overflow has occurred to the queue with respect to said user;
if no overflow is detected:
reading a queued data event based upon said read pointer;
updating said read pointer based upon said first predetermined manner; and
updating said previous event counter value; and
if overflow is detected:
updating said read pointer based upon a second predetermined manner;
reading at least one queued data event based upon said read pointer;
updating said read pointer based upon said second predetermined manner; and
updating said previous event counter value.

28. The method according to claim 27, further comprising after each read of said queue where no overflow is detected:
determining a new current count value;
comparing said new current count value to said previously stored count value to determine whether overflow has occurred; and
if overflow is detected:
updating said read pointer based upon a second predetermined manner;
reading at least one queued data event based upon said read pointer;
updating said read pointer based upon said predetermined manner; and
updating said previous event counter value.

29. The method according to claim 27, wherein said read pointer is updated to a new position that corresponds to a current value of said write pointer.
